(19) United States
(12) Patent Application Publication
(10) Pub. No.: US 2009/0057316 A1
(43) Pub. Date: Mar. 5, 2009

(54) Coil nut

(76) Inventors: Fred M. Schweinberg, Knoxville, TN (US); Wiley R. Tipton, Friendsville, TN (US); Michael E. Fisher, Knoxville, TN (US); Phillip K. Stephens, Knoxville, TN (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/896,481

(22) Filed: Aug. 31, 2007

(51) Int. Cl. F16B 33/02

(52) U.S. Cl. 220/325

(57) ABSTRACT

An electrical enclosure includes an electrical box and a cover mounted onto the electrical box. A 3/8-7 lag bolt extends through the cover and engages a coil nut for securing the cover to the electrical box or underground enclosure. The coil nut includes a body having two ends with an aperture therebetween. The aperture has a continuous internal thread formed between the first and second ends. The size of the continuous internal thread is seven individual threads per inch such that the distance, or pitch, between first and second centers of first and second threads, respectively is 0.143 inches. The pitch and the diameter determine the seven threads per inch size of the continuous thread by accounting for the minor diameter and the major diameter of the nut.

### FIELD OF THE INVENTION

The present invention relates to a coil nut developed to fit onto a ⅜-7 lag bolt and also designed to retrofit onto existing products. More particularly, the present invention relates to a coil nut having a nut body with first and second ends and an aperture therebetween. A continuous thread is formed within the aperture having a size of seven threads per inch. Each of the individual threads are spaced such that the distance between a center of a first thread and a center of a second thread is 0.143 inches.

### BACKGROUND OF THE INVENTION

Conventional coil nut apertures have diameters equal to or larger than six threads per inch of space for fitting ½-6 lag bolts. This sizing affects the inclination to gather dirt. Also, the conventional coil nuts with less open threads are less likely to seize the nut together with a bolt.

Often, conventional coil nuts are expensive to manufacture and do not fit small product sizes to provide a rigid interface between a bolt and a nut. With restricted sizes, multiple tools are needed to work in conjunction with a ⅜-7 lag bolt, while providing the same design benefits as a ½″ model.

A need exists for a coil nut that provides the same design benefits as the ½″ model at a lower cost. A need also exists for providing a coil nut designed to fit existing products that can be retrofitted into existing installations as easily as the replacement of the original insert.

Conventional nuts include 16 threads per inch. This creates problems because this configuration does not detract debris. The debris interferes with the connection between the bolt and the nut when the two are coupled. A need exists for a coil nut with a coarse structure that decreases the amount of dirt stuck between the individual threads of the nut.

Designs of coil nuts are disclosed in U.S. Pat. No. 5,088,868 to Cosenza et al., U.S. Pat. No. 6,726,420 to Ward et al., and U.S. Pat. Appln. No. 2007/0031210 to Schmidt, which are hereby incorporated herein by reference. While these prior art coil nut designs cause debris to be deflected, they are oftentimes too large for the desired applications.

Consequently, a need exists for a less expensive coil nut that can deflect debris from between the threads with as many threads per inch as possible.

### SUMMARY OF THE INVENTION

Accordingly, an object of the present invention is to provide a coil nut with seven threads per inch.

Another object of the invention is to provide a coil nut having a retrofit feature to easily work with products from the original insert.

A further object of the invention is to provide a coil nut having a retrofit feature to fit a variety of bolt lengths.

Still another object of the invention is to provide a coil nut having a ⅜-7 size that works in conjunction with a ⅜-7 lag bolt while providing the same design benefits as a ½″ model.

The foregoing objects are basically attained by providing a coil nut having a body with first and second ends and an aperture therebetween for receiving the bolt. A continuous thread is formed between the first and second ends within the aperture. The size of the thread is seven threads per inch to be fitted onto a ⅜-7 lag bolt.

By forming the coil nut in this manner, the coil nut can fit a ⅜-7 bolt, while inexpensively providing the same design benefits as a ½″ model. This design enables the nut to withstand debris since the orientation of the ⅜-7 size creates a more course structure than conventional nuts. Also, the coil nut is sized for existing products so it can be retrofitted into installations as easily as the replacement of the original insert.

As used in this application, the terms “top”, “bottom”, and “side” are intended to facilitate the description of the coil nut, and are not intended to limit the description of the coil nut to any particular orientation.

Other objects, advantages, and salient features of the present invention will become apparent from the following detailed description, which, taken in conjunction with the annexed drawings, discloses preferred embodiments of the invention.

### BRIEF DESCRIPTION OF THE DRAWINGS

Referring to the drawings which form a part of this disclosure:

FIG. 1 is a perspective view in section of a corner box prior to inserting a bolt into a ⅜-7 lag nut according to an embodiment of the present invention;

FIG. 2 is a perspective view in section of the corner box of FIG. 1 with the bolt threaded into the coil nut and the door closed;

FIG. 3 is a top elevational plan view of the coil nut of FIG. 1;

FIG. 4 is a side elevational view in section of the coil nut of FIG. 3 taken along line 4-4; and

FIG. 5 is an enlarged side elevational view in section of the circle Z shown in FIG. 4.

Throughout the drawings, like reference numerals will be understood to refer to like parts, components, and structures.

### DETAILED DESCRIPTION OF THE INVENTION

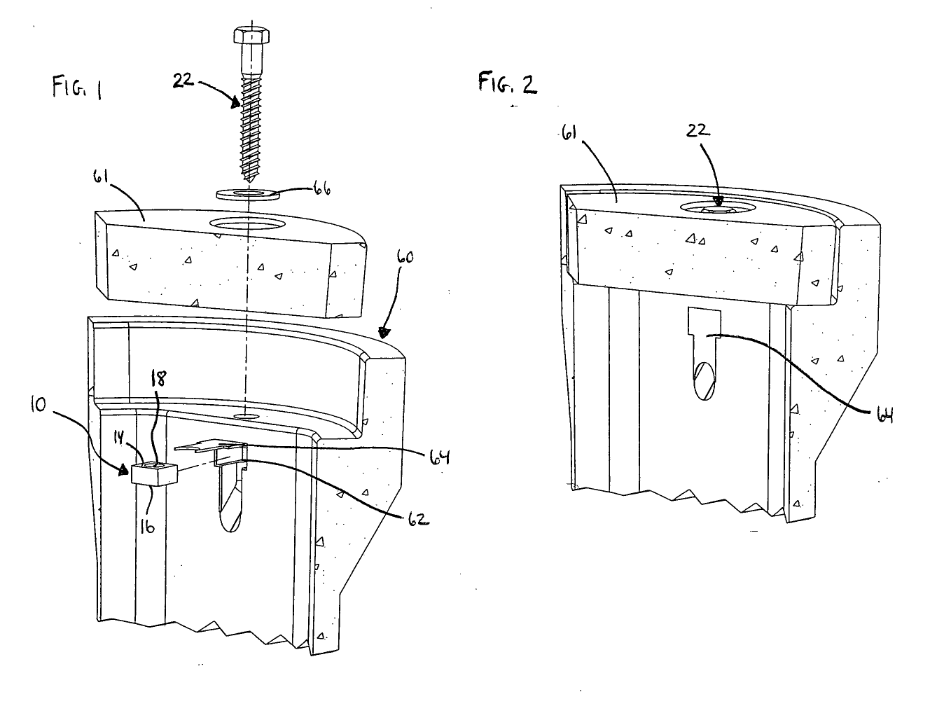

As seen in FIGS. 1-5, the coil nut 10 comprises a body having a first end 14 and a second end 16 and an aperture 18 therebetween. A continuous internal thread 20 adapted to be fitted onto a ⅜-7 lag bolt 22 is formed between the first end 14 and the second end 16 within the aperture 18. The size of the continuous thread 20 is seven threads 30 per inch.

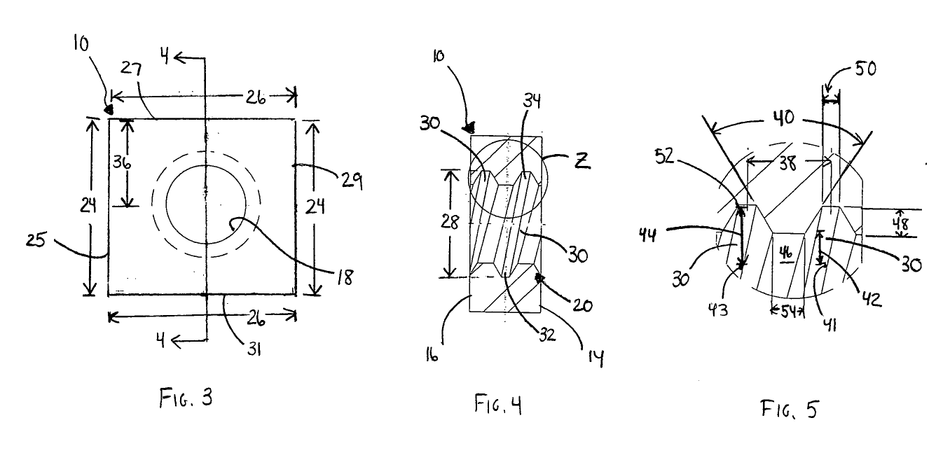

The coil nut 10 is preferably manufactured of 18-8 stainless steel or an equivalent material. The shape of the nut 10 can be square or hexagonal. As illustrated in FIG. 3, the nut 10 is defined by a square shape wherein the length 24 of first side 25 and third side 29 and the width 26 of second side 27 and fourth side 31 of the nut 10 are each equal to approximately 0.63 inches.

The aperture 18 is located in the middle of the nut 10 such that the center of the aperture 18 is also the center of the nut 10. Therefore, the distance 36 from the center of the nut 10 to the outer edge of the nut is equal to ½ the length or width of the nut 10. Thus, the distance 36 is approximately 0.31 inches.

The pitch 38 of the continuous thread 20 relates to the number of threads per inch applied to a single diameter. Pitch 38 takes into account the minor diameter 42 and the major diameter 44 of the nut 10. The minor diameter 42 is the smallest diameter of the thread 30 and the major diameter 44 is the largest diameter of the nut 10. Therefore, the angle 40 of the continuous thread 20, as illustrated in FIG. 5, is 60°. A first center 41 of a first thread 30 is spaced from a second center 43 of a second thread 30 by a distance of approximately 0.143 inches, also known as the pitch.

Turning to FIG. 4, the diameter 28 of the aperture 18 is equivalent to the distance between the first outer end 32 and the second outer end 34 of each thread 30. The diameter 28 is approximately equal to 0.375 inches. The pitch 38 together with the diameter 28 determine the threads per inch.

The continuous thread 20 includes seven individual threads 30 per inch. Each of the threads 30 extends from an interior column or root 46 along the aperture 18 to connect the crest or outer ends of each of the individual threads 30. From this root 46, each of the threads 30 has a protruding distance away from the root 46 towards the outermost ends or crests of the threads 30. As illustrated in FIG. 5, the difference 48 between the minor diameter 42 and the major diameter 44 is approximately 0.050 inches.

Each thread 30 further includes a peak 52 along the planar region of its exterior edge. The peak 52 is the planar region along the widest edge of the thread 30. The width 50 of the planar region is approximately 0.032 inches.

The specific size of the thread 20 is unique to the coil nut 10 because it provides a solution for the smaller size bolt and is designed to work in conjunction with a ⅜-7 lag bolt. Each of the individual threads 30 is spaced along the aperture 18 at distances of approximately 0.055 inches apart from each other as measured from the point where each thread 30 abuts the root 46, and illustrated by distance 54.

One of the coil nut 10 advantages is to fit previously designed products that need larger, more open threads that are less inclined to gather dirt. The extended distance between the threads 30 and the measurements disclosed herein allow the coil nut 10 to withstand debris that passes through the threads because of the course structure resulting from the specific size.

As seen in FIGS. 1 and 2, the coil nut 10 is inserted into a corner electrical box or underground enclosure 60 for receiving a bolt 22. The underground enclosure 60 includes a cover 61 mounted thereon and secured to the underground enclosure 60 with the bolt 22 and coil nut 10. Prior to installation, a standard nut is removed from the corner box aperture 62. An electrical box door 64 pivots to receive the coil nut 10 into the appropriately sized aperture 62. Once installed, the coil nut 10 receives the bolt 22 after the bolt 22 is inserted into the washer 66 and cover 61. The door 64 closes to secure the nut 10 and receive the bolt 22 for installation.

While a particular embodiment has been chosen to illustrate the invention, it will be understood by those skilled in the art that various changes and modifications can be made therein without departing from the scope of the invention as defined in the appended claims.

What is claimed is:

1. An electrical enclosure, comprising:
an electrical box;
a cover mounted on said electrical box;
a coil nut mounted in said electrical box, said coil nut having a body with a first end, a second end and an aperture between said ends, said aperture having a continuous internal thread therein between said first and second ends, said internal thread having seven threads per inch; and
a ⅜-7 lag bolt extending through said cover and engaging said coil nut to secure said cover to said electrical box.

2. An electrical enclosure according to claim 1 wherein
said first end receives the bolt.

3. An electrical enclosure according to claim 1 wherein
a first center of a first thread is spaced from a second center of a second thread by a distance of approximately 0.143 inches.

4. An electrical enclosure according to claim 3 wherein
each of said threads includes an angular displacement of approximately 60°.

5. An electrical enclosure according to claim 1 wherein
a first side of said coil nut is approximately 0.63 inches and a second side of said coil nut is approximately 0.63 inches.

6. An electrical enclosure according to claim 1 wherein
each of said threads has a diameter of approximately 0.375 inches.

7. An electrical enclosure according to claim 1 wherein
said threads are spaced along said aperture at a root distance of approximately 0.055 inches.

8. An electrical enclosure according to claim 1 wherein
each of said threads includes a peak along an exterior edge thereof, said peak has a width of approximately 0.032 inches.

9. An electrical enclosure according to claim 1 wherein
a column connecting each of said threads and outer ends of each of said threads is spaced by a distance of approximately 0.050 inches.

10. An electrical enclosure comprising:
an electrical box;
a cover mounted on said electrical box;
a coil nut mounted in said electrical box, said coil nut having a body with a first end, a second end and an aperture between said ends, said aperture having a continuous internal thread therein between said first and second ends, said internal thread having seven threads per inch;
a ⅜-7 lag bolt extending through said cover and engaging said coil nut to secure said cover to said electrical box; and
a first center of a first thread is spaced from a second center of a second thread by a distance of approximately 0.143 inches.

11. An electrical enclosure according to claim 10 wherein
each of said threads includes an angular displacement of approximately 60°.

12. An electrical enclosure according to claim 10 wherein
said body is manufactured of 18-8 stainless steel.

13. An electrical enclosure comprising:
a body having a first end adapted to receive a bolt and a second end with an aperture therebetween;
a continuous thread formed between said first end and said second end within said aperture and having seven threads per inch, with said aperture, said continuous thread is formed to mate with a ⅜-7 lag bolt; and
an electrical box adapted to receive at least one of said first and second ends wherein the box includes a cover and said nut is threaded to the bolt for securing the cover to the electrical box.

14. An electrical enclosure according to claim 13 wherein
a first center of a first thread is spaced from a second center of a second thread by approximately 0.143 inches.

15. An electrical enclosure according to claim 13 wherein
each of said threads includes an angular displacement of approximately 60°.

16. An electrical enclosure according to claim 13 wherein
said first end receives the bolt.
